(19) United States
(12) Patent Application Publication
(10) Pub. No.: US 2025/0187637 A1
(43) Pub. Date: Jun. 12, 2025

(54) AUTONOMOUS UNMANNED AERIAL VEHICLE BASED INTELLIGENT INSPECTION SYSTEM FOR EQUIPMENT, FACILITIES, AND THE ENVIRONMENT ALONG RAILWAY LINES AND METHOD THEREOF

(71) Applicant: Beijing Jiaotong University, Beijing (CN)

(72) Inventors: Yong QIN, Beijing (CN); Zhipeng WANG, Beijing (CN); Huaizhi YANG, Beijing (CN); Jing CUI, Beijing (CN); Yixuan GENG, Beijing (CN); Chongchong YU, Beijing (CN); Fanteng MENG, Beijing (CN); Changhong SHAO, Beijing (CN); Yunpeng WU, Beijing (CN); Rigen HOU, Beijing (CN)

(21) Appl. No.: 18/532,228

(22) Filed: Dec. 7, 2023

(51) Int. Cl. B61K 9/08; B64U 80/30; B64U 101/30; G05D 1/617; G06T 7/00

(52) U.S. Cl. CPC B61K 9/08; B64U 80/30; G05D 1/617; G06T 7/0004; B64U 2101/30; B64U 2201/10

(57) ABSTRACT

The present invention provides an automatic intelligent inspection system for the equipment, facilities and surrounding environment along a railway line, including an unmanned aerial vehicle (UAV), a movable ground base station, a remote server and a working computer, wherein the working computer includes an image processing module that is configured to detect an obtained image by using a deep learning network model trained with a database in advance, obtain any object that is suspected to involve a defect by analysis, and transmit the object for manual review while calculating for the specific geographic coordinate information of the defect, report for early warning after the defect is confirmed by the manual review, inform the operation and maintenance personnel, and store and record the defect. The present invention further provides a method for inspection by using the automatic intelligent inspection system for the equipment, facilities and surrounding environment along a railway.

### TECHNICAL FIELD

The present invention relates to the technical field of inspection of the equipment along a railway line and automatic flight inspection of an unmanned aerial vehicle (UAV), in particular to an automatic intelligent inspection system for the equipment, facilities and surrounding environment along a railway line, which can be used for the automatic intelligent inspection of the equipment and surrounding environment along a high-speed railway line.

### BACKGROUND

The parts along the railway line may be damaged or even lost easily because of the surges and vibrations in the operation of trains. At present, the main detection method is to read a great deal of image data in an off-line mode by humans and to make visual inspections on these image data. However, with the large-scale construction of high-speed electrified railways, there are a vast number of images to be visually inspected by humans, and the inspection efficiency is very low. Meanwhile, different cameras mounted on inspection vehicles usually take images at night, consequently the obtained images are of poor quality and there may be missing images.

Besides, the change of the surrounding environment along the railway line also has a severe impact on the safe operation of the railway. In addition, the surrounding environment along the railway line is extensive and has a large coverage, and is difficult to supervise. Various illegal buildings, illegal construction activities, and debris dumps may exist along the railway line, causing non-negligible impacts on the safe operation of the railway.

Therefore, it is of great significance to improve the operation, maintenance, management, and safe operation of the equipment and facilities along the railway by using a UAV to take high-definition images of the equipment, facilities and surrounding environment along the railway and using a deep learning object detection algorithm to realize automatic detection of defective equipment and facilities along the railway and hidden risks in the surrounding environment.

In recent years, with the development of the image processing technology, the deep learning object detection technology has been rapidly developed and improved. By creating a database of the equipment, facilities and surrounding environment along the railway line, the captured images can be automatically detected.

As the development of UAV technology is gradually matured, the manufacturing cost is greatly reduced, and UAVs have been widely applied in various fields. However, during the flight of an UAV, the UAV may be easily affected by natural factors such as strong wind, so the situations in which the projection area for capturing images of the camera carried on the support platform of the UAV deviates from the railway line often occur. If the real-time state of the support platform of UAV and the camera carried on the UAV are not judged and adjusted, the acquired rail area information will be incomplete, and the missing detection or faulty format of the failure information may occur, which may eventually lead to the decrease of efficiency and reliability of rail inspection.

Therefore, it is necessary to automatically identify and keep track of the rails of a railway in real time to guide an UAV to automatically acquire comprehensive and well-formed rail information.

### SUMMARY OF THE INVENTION

The present invention provides an UAV-based automatic intelligent inspection system for high-speed railways, which solves the problems of low inspection efficiency, low inspection frequency, and incomplete inspection by means of manual inspection in the prior art.

To achieve the above object of the present invention, the present invention provides an automatic intelligent inspection system for the equipment, facilities and surrounding environment along a railway line, which comprises:
an unmanned aerial vehicle (UAV) configured to fly along the railway according to a preset trajectory, acquire and store image information of the equipment, facilities and surrounding environment along the railway line from a plurality of perspectives, and transmit the image information to a remote server;
a movable ground base station configured to enable the UAV to replace batteries and load, dump data locally, and take off and land autonomously by using a ground landing platform;
a remote server configured to receive and store the image information transmitted by the UAV;
a working computer configured to receive the image information acquired by the UAV and transmitted by the remote server, and analyze and compute the image information, so as to obtain an inspection result;
the working computer comprises an image processing module, which detects the obtained image by using a deep learning network model trained with a database in advance, obtaining any object that is suspected as a defect by analysis, and sends the object for manual review while calculating for the specific geographic coordinate information of the defect, reports the defect for early warning after the defect is confirmed by the manual review, informs the operation and maintenance personnel to handle the defect, and stores and records the defect,
   wherein the image processing module comprises an image preprocessing and integration algorithm, a deep learning network model and a post-processing algorithm for the detection result, wherein the deep learning network model comprises a CYOLO-based fastener defect detection algorithm for railways, a rail surface segmentation algorithm that is based on a rail edge guidance saliency detection network (RBGNet), a defect detection algorithm for the steel structure surface of bridge based on improved YOLOv5 for bridges, and an abnormality detection algorithm for the railway surrounding environment that is based on multi-source data fusion for environments.

Furthermore, the UAV comprises a body power module, a flight control and navigation module, an embedded onboard module, a link system module, a safety protection module, a LIDAR module, an infrared thermal imaging module, and an image acquisition module, wherein the body power module forming a main structure of the UAV comprises arms, motors, blades, batteries, a tripod and a support platform;
the flight control and navigation module are configured to feed back the geographic coordinate information where the UAV locates in real time, control the start and stop, flight altitude and flight speed of the UAV, and enable the UAV to fly according to the preset flight trajectory;
the embedded onboard module utilizes an onboard computer with optimized information transmission and storage capability and data and image processing capability to realize data processing in flight;
the link system module is configured to upload UAV control instructions and download mission information, and transmit the working state and video images of the UAV in real time;
the safety protection module is configured to confirm a specific route of the UAV according to the specific location and surrounding environment of the UAV in conjunction with the working purpose of the UAV;
the LIDAR module accurately detects the distance and the altitude by means of echo signals, so as to carry out construction of three-dimensional view to design cruise trajectory, realize high-precision inspection with the UAV by means of sensors, while acquiring point cloud data of the surrounding environment along the railway line;
the infrared thermal imaging module accurately presents the operating state of the railway infrastructure and equipment by means of a temperature measurement function; and
the image acquisition module is configured to acquire and store the image information of the equipment, facilities and surrounding environment along the railway line in the flight route of the UAV.

Furthermore, the RBGNet-based rail surface segmentation algorithm consists of four modules and a supervised saliency detection, wherein the four modules include a backbone network that is based on an improved residual block (IRB), an extraction module of the rail edge saliency features, an extraction module of the rail surface saliency feature, and a guidance module.

Furthermore, the extraction module of rail surface saliency feature is configured to produce features with multi-resolution, add a convolution operation to the edge paths of the backbone network to obtain more saliency information of the rail surface, and add a nonlinear activation function layer after each convolution layer to ensure the nonlinearity of the model.

Furthermore, the defect detection algorithm for bridge steel structure surface that is based on improved YOLOv5 for bridges is a one-stage object detection algorithm based on a convolutional neural network, in which the Bottleneck in the YOLOv5 algorithm is replaced with Ghost Bottleneck.

Furthermore, the abnormality detection algorithm for railway surrounding environment based on multi-source data fusion for environments comprises:
carrying out feature analysis and data preprocessing on the point cloud data, segmenting the point cloud data by using a large-scale point cloud semantic segmentation model based on random sampling, feature aggregation and prototype fitting, clustering the point cloud by using an improved Euclidean algorithm, identifying the object by using a deep learning instance segmentation method based on transfer learning, and finally, intelligently identifying the abnormalities of the environment around the railway by using a method of fusing the point cloud data and a visible light image recognition result in the serial decision level.

Furthermore, the embedded onboard module comprises:
a network access terminal for onboard data configured to realize real-time network access from the UAV in the air; and
an onboard edge computer configured for realizing millisecond-level real-time data transmission between the ground and the UAV via signals, wherein the embedded onboard module realizes autonomous identification and real-time tracking of the rail route by using a Largest Connected-ERFNet model algorithm.

Furthermore, the Largest Connected-ERFNet model comprises an ERFNet deep learning portion and a Largest Connected Component deep learning portion, wherein the framework of the ERFNet deep learning portion is as follows:
i. randomly selecting a corresponding number of remote sensing images from an original training data set: firstly, the image inputted to model is encoded; the encoding portion consists of a down-sampling module and an encoding residual module, wherein the down-sampling module is realized by convolution operation and max-pooling operation;
ii. the encoding residual module employs the residual module in Non-bottleneck-1D, with the last two blocks in Non-bottleneck-1D replaced with one-dimensional dilated convolution for refined extraction of sample image features;
iii. decoding the feature image after the sample image feature extraction is completed by the encoding portion; the decoding portion consists of an up-sampling module and a decoding residual module, wherein the up-sampling portion employs deconvolution with a step size of 2, and the decoding residual module and the encoding residual module employ Non-bottleneck-1D to refine the image features converted by up-sampling;
iv. after the up-sampling and residual operation of the decoding portion, the resolution of the generated output image is restored to the level of the originally inputted image, and different types of areas in the image are labelled with different colors to distinguish them, so as to achieve a purpose of semantic segmentation of different types of objects in the image.

Furthermore, the Largest Connected Component deep learning portion is configured to extract the largest connected component, including:
i. binarizing the image: the image is regarded as an entire area, and the remote sensing image is converted into a binary image with pixel values of 0 or 255 after dividing the rail area, and the pixel neighborhood relationship includes four neighboring pixel relationship and eight neighboring pixel relationship;
ii. determining a connected component: the pixels of the binary image is traversed to find an edge pixel of a connected component, wherein the edge pixel is the first pixel that the pixel value changes; the pixels in a neighborhood relationship with this edge pixel are judged; pixels having the same pixel value as this edge pixel is allocated to the same connected component; the subject matter of calibration is moved to a neighboring pixel of the same type; pixels in a neighborhood relationship with the current pixel are judged again, and so on, till there is no pixel position that can be calibrated; the calibrated pixel points together constitute a connected component; and
iii. repeating the process (ii) to complete the processing of all pixels in the image, so as to obtain all connected components contained in the image.

Furthermore, the safety protection module comprises:
an electronic fence established around the area where the UAV is forbidden to enter to ensure that the UAV will not invade the safety clearance in the flying operation;
an under-voltage protection module configured to remind the user of flying back or landing the UAV in time when the voltage is too low;
a one-button return switch configured for activating a one-button return function of the UAV;
a safety mode setting module configured for automatically switching to a manually operated flight when the UAV is interfered; and
a link disconnection protection module configured to fly back to a landing point according to a preset return route when the link is disconnected.

Furthermore, the image acquisition module comprises:
a high-resolution lens configured for acquiring image data;
an image acquisition control chip configured for receiving the location information of the UAV, taking images at an interval of flight distance or flight time, and receiving the image information from the camera at the same time, and detecting whether there is a target area in the image during hovering for taking images in the multi-mission flight; and, if there is a target area, giving a shooting command; otherwise transmitting a signal to the flight control and navigation system of the UAV to adjust the location of the UAV.

Furthermore, the movable ground base station comprises:
a device replacement module configured for receiving the UAV, replacing the batteries of the UAV, automatically replacing the load as required, and charging and storing the replaced batteries;
a data dumping module configured for dumping and backing up the data acquired by the UAV after the UAV arrives at the ground base station; and
a ground take-off and landing module configured for one-button autonomous take-off and landing of the UAV, offsite take-off and landing of the UAV, and providing energy support for field operations.

Furthermore, the working computer further comprises:
a monitoring module configured to issue an automatic flight inspection mission to the UAV after accurately planning the flight route according to the LIDAR data, and monitor the flight state of the UAV in real time; and
a data dumping module configured for receiving the data returned by the ground base station and classifying and storing the data into a database of the equipment, facilities and surrounding environment along the railway line.

Furthermore, the step of configuring the monitoring module comprises:
directly using the geographic coordinate information for route planning to realize automatic cruising, or taking over the UAV flight control system in real time via the monitoring system to remotely control the flight of the UAV when the UAV is to inspect the target area for the first time; and
carrying out three-dimensional modeling of the target area by using the point cloud data obtained by the LIDAR module after the first flight, determining the flight trajectory of the UAV accurately, configuring the UAV to hover at the communication towers along the railway line for taking images, and taking images after reaching the target area.
   To achieve the above object of the present invention, the present invention further provides a method for inspection by using the above-mentioned automatic intelligent inspection system for the equipment, facilities and surrounding environment along the railway line, which comprises the following steps:
configuring the image processing module;
configuring a planned flight route of the UAV, issuing a take-off command to the UAV for the inspection mission, monitoring the entire flight process of the UAV, and taking over the flight control of the UAV at any time, via the monitoring module of the working computer;
after the UAV enters the flight mission area, carrying out image acquisition according to a preselected setting, making real-time adjustment according to the actual flight state, and saving the geographical location information of the captured images together with the captured images, via the image acquisition module in the UAV; and
during the inspection flight mission of the UAV, transmitting the flight data and location information of the UAV to a flight mission server in real time by means of mobile communication signals, monitoring and managing the data via the server, returning the UAV data via the ground base station, detecting and identifying the defects in the newly received image information via the deep learning network model in the image processing module, sending a defect warning result for manual review, uploading the defect and specific location information after the defect is manually confirmed, and informing the operation and maintenance personnel and recording the defect, wherein the flight data includes the acquired image data.

Furthermore, the steps of configuring the image processing module comprise labelling the acquired images of the equipment, facilities and surrounding environment along the railway line, creating a data set, and training the defective object detection model based on a deep learning network to realize automatic identification and positioning of the defect in the newly acquired data.

Furthermore, after the database of the equipment, facilities and surrounding environment along the railway line is created, automatically labelling the newly acquired images by using the deep learning network model, supplemented by manual detection and labelling, updating the database, and training and optimizing the network model again to enhance the detection ability.

The present invention has the following advantages and beneficial effects:
(1) By utilizing a UAV to take images of the equipment, facilities and surrounding environment along the railway line, remote sensing images with better image quality can be obtained without affecting the operation of the railway, and the safety of train operation can be ensured. Incomplete data caused by occlusion can be avoided since the shooting angle can be varied.
(2) Deep learning algorithms are applied to the detection of the acquired railway images to realize automatic identification of the defective equipment and facilities along the railway line and the potential risks in the surrounding environment, and improve the efficiency of detection.
(3) The UAV relies on a planned flight route for inspection and the onboard LIDAR and GPS system for differential positioning and navigation, and achieves high flight accuracy and high safety. The flight control module can adjust the flight attitude of the UAV in real time under complex weather conditions to ensure the safe flight of the UAV and the quality of the captured images.
(4) An onboard rail line identification and tracking method is used to take the place of drone pilot to reduce the manpower consumption in the railway inspection mission, and image semantic segmentation in the deep learning method is used to achieve high adaptability to the surrounding environment and high accuracy.
(5) The flight path can be planned, and the flight mission of the UAV can be issued at the working computer, without the need for personnel to control the UAV on the spot, thereby the workload of the personnel as well as the requirements for manual operation are reduced.
(6) In the flight process of the UAV, battery replacement and load replacement can be carried out at the ground base station.

### DESCRIPTION OF DRAWINGS

FIG. 1 is a schematic structural diagram of the inspection system of the equipment, facilities and surrounding environment along a railway line according to the present invention;

FIG. 2 is a schematic diagram of the framework of the deep learning portion of the Largest Connected-ERFNet model;

FIG. 3 is a schematic diagram of the division result of rail area;

FIG. 4 is a schematic diagram of the screening and extraction result of the division result of rail area;

FIG. 5 is a schematic structural diagram of a CYOLO network;

FIG. 6 is a schematic diagram of the defect detection result of some fasteners;

FIG. 7 is a schematic structural diagram of a rail boundary guidance saliency detection network (RBGNet);

FIG. 8 is a schematic diagram of the steps of a maximum entropy threshold method of grayscale extension;

FIG. 9 is a schematic diagram of the enhancement effect based on local Weber-like law;

FIG. 10 is a schematic diagram of the detection result based on local Weber-like law and maximum entropy of grayscale extension;

FIG. 11 is a schematic diagram of the improved framework of YOLOv5 model;

FIG. 12 shows the detection result of steel structure defects of some railway bridges;

FIG. 13 is a schematic diagram of a large-scale point cloud semantic segmentation network;

FIG. 14 is a schematic diagram of method of fusing the point clouds and visible light image in a decision level;

FIG. 15 is a flow chart of the inspection system for the equipment, facilities and surrounding environment along a railway line according to the present invention;

FIG. 16 is a schematic diagram of the railway data taken by a UAV;

FIG. 17 is a schematic diagram of the working principle of the intelligent analysis system for inspection of the equipment, facilities and surrounding environment along a railway line according to the present invention;

FIG. 18 is a schematic diagram of the main inspection method of a UAV for a high-speed railway;

FIG. 19 is a schematic diagram of the flight range of a UAV in an inspection mission for combined operation of high speed railway operation and environment;

FIG. 20 is a schematic diagram of the flight range of a UAV for inspection of a high-speed railway at bridges; and

FIG. 21 is a schematic diagram of the flight range of a UAV for inspection of a high-speed railway in mountainous areas and at tunnel entrances.

### DETAILED DESCRIPTION AND EMBODIMENTS

Some embodiments of the present invention will be detailed below, with reference to the accompanying drawings. While some embodiments of the present invention are illustrated in the drawings, it should be understood that the present invention can be embodied in various forms and should not be construed as limited to the embodiments set forth herein; on the contrary, those embodiments are provided only for a more thorough and complete understanding of the present invention. It should be understood that the drawings and embodiments of the present invention are only for an illustrative purpose, but are not intended to limit the scope of protection of the present invention.

It should be understood that the steps described in the method embodiments of the present invention can be performed in a different order and/or in parallel. Besides, the method embodiments may include additional steps and/or omit some illustrated steps. The scope of the present invention is not limited in this respect.

As used herein, the term “comprising” and its variants means open-ended including, i.e., “including but not limited to”. The term “based on” means “at least partially based on”. The term “an embodiment” means “at least one embodiment”; the term “another embodiment” means “at least one other embodiment”; the term “some embodiments” means “at least some embodiments”. The related definitions of other terms will be given in the following description.

It should be noted that the modifying words “a/an” and “a plurality of” mentioned in the present invention are illustrative rather than limiting, and those skilled in the art should understand that they should be understood as “one or more” unless the context clearly indicates otherwise; “a plurality of” should be understood as two or more.

The present invention provides an automatic intelligent inspection system for the equipment, facilities and surrounding environment along a railway line, which takes images along the railway line during automatic cruising of a UAV and inputs the obtained images into an intelligent analysis system to realize automatic detection of defects in the infrastructure and surrounding environment along the railway line.

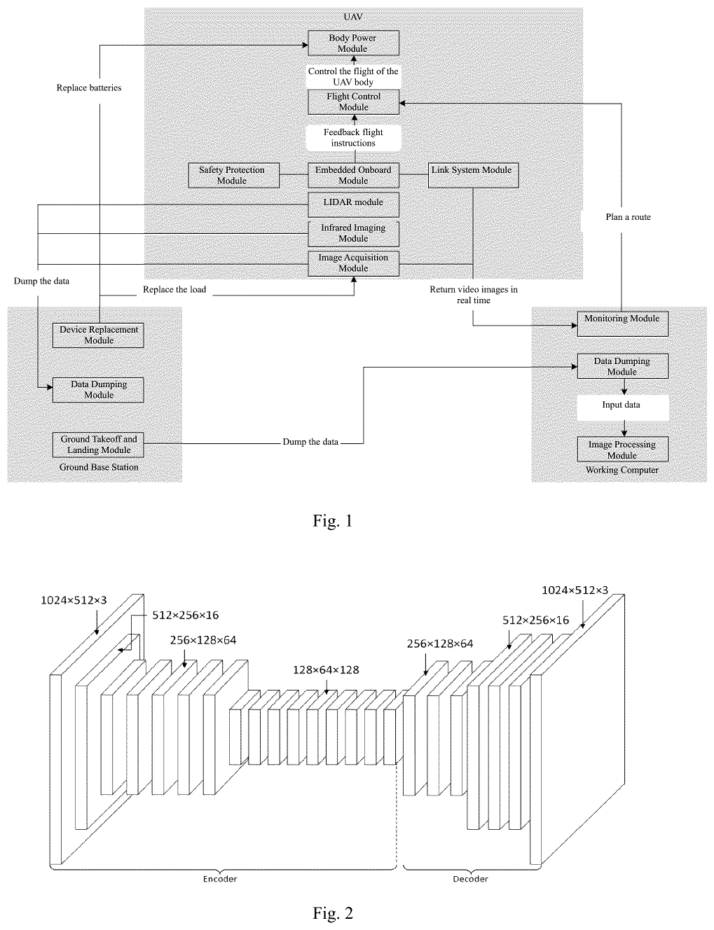

As shown in FIG. 1, the automatic intelligent inspection system for the equipment, facilities and surrounding environment along a railway line comprises an unmanned aerial vehicle (UAV), a movable ground base station, and a working computer at terminal.

The automatic intelligent inspection system for the equipment, facilities and surrounding environment along a railway line may further comprise a remote server for receiving and storing the image information transmitted by the UAV.

The unmanned aerial vehicle mainly comprises a body power module, a flight control and navigation module, an embedded onboard module, a link system module, a safety protection module, a LIDAR module, an infrared thermal imaging module, and an image acquisition module.

For the UAV, it is required that the UAV is compatible with the mission load subsystem, and the UAV may be mounted on a platform and receive information and instructions from a ground controller to realize flight operation; it is advisable to use a lightweight or miniature UAV; the UAV should have an airspace maintenance ability and an ability of being reliably monitored according to the requirements of airspace management.

The body power module comprises a UAV body; a plurality of rotary arms arranged on the UAV body in a plurality of directions, each of arms is provided with a motor, and each motor is equipped with two blades; a plurality of UAV batteries are arranged on the UAV body for supplying power to the UAV; it also includes a tripod for the take-off and landing of the UAV; and a support platform for the configuration of LIDAR module and the installation of image acquisition module.

The flight control and navigation module comprises a three-axis gyroscope for sensing the flight attitude; a tri-axial accelerometer; a tri-axial geomagnetic inductor; a barometric pressure sensor for roughly controlling the hovering height; an ultrasonic sensor for precise control at low altitude or avoidance of the obstacle; an optical flow sensor for accurately determining the horizontal position during hovering; a GPS module for roughly determining the altitude corresponding to the horizontal position; and a control circuit.

The flight control and navigation module calculates the real-time difference between the geographic coordinate information obtained by means of Beidou navigation and the radar position information to ensure the accuracy of the flight trajectory; when the flight attitude of the UAV changes or the position of the UAV deviates owing to strong wind or other unexpected circumstances, the flight control and navigation module will adjust the attitude of the UAV automatically to ensure successful completion of the flight mission.

The embedded onboard module Is equipped with an onboard data access terminal to communicate with the ground base station, so that the UAV can access the network in real time during flight. An onboard edge computer in the embedded onboard module realizes millisecond-level real-time data transmission between the ground and the UAV via signals, so that the ground personnel can obtain flight data and images more rapidly and the UAV can respond to the ground operations more rapidly. The embedded onboard module is embedded with a Largest Connected-ERFNet semantic segmentation algorithm model, which is deployed in the onboard terminal of the UAV after model training; it divides and extracts real rail areas from the remote sensing images acquired in real time during the flight of the UAV, and, on that basis, automatically calculates the relative coordinates of two rail lines and other information to judge the information validity of the rail area images at the current moment, from then on, identification of the rail line of single frame image is completed. It completes continuous autonomous identification of the rail line from the real-time video stream collected by the UAV, and adjusts the corresponding solution against abnormal situations on the basis of the result of autonomous identification, so as to realize the function of real-time tracking the rail line.

### Embodiment 1

The framework structure of the Largest Connected-ERFNet model includes: the Largest Connected-ERFNet model is designed specific to the inspection scenario of a railway line with a UAV and the characteristics of the remote sensing images, and consists of two portions: ERFNet portion and Largest Connected Component portion. The ERFNet portion is the deep learning algorithm of the Largest Connected-ERFNet model, and is used to implement rail area division from the remote sensing images acquired by the UAV to achieve rough division of the rail areas; the Largest Connected Component portion is used to implement the result optimization of the Largest Connected-ERFNet model, the aim of the Largest Connected Component portion is directed to irrelevant background interference caused by small objects in the remote sensing images acquired by the UAV. The optimization method is to find the connected component that contains the richest information from the rail area division result and identity the connected component as a required real rail area, and identify the rest connected components with less information as interference areas and exclude them from the subsequent data calculation.

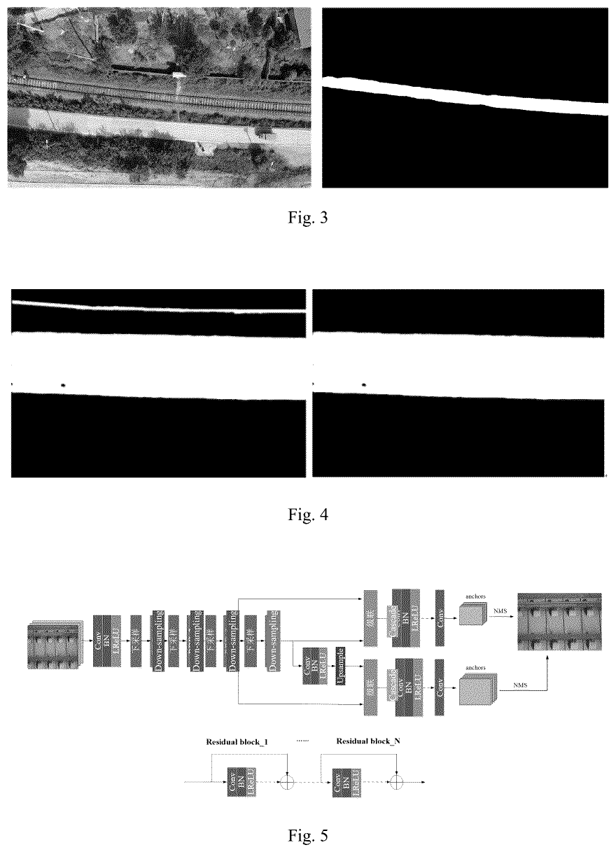

As shown in FIG. 2, the basic framework of the deep learning portion of the Largest Connected-ERFNet model can be summarized as follows:
i. A corresponding number of remote sensing images are randomly selected from the original training data set, and firstly the images inputted to the model are encoded. The encoding portion consists of a down-sampling module and a residual module, and has 16 layers in total. The down-sampling module is realized by using 3×3 convolution operation and 2×2 max-pooling operation, and is used to implement rough extraction of features of the sample images. The encoding portion performs the down-sampling operation for three times;
ii. The residual module of the encoding portion employs a brand-new residual module that is referred to as Non-bottleneck-1D instead of a conventional residual module; in addition, in order to improve the information accuracy of features extracted by the network, the last two blocks in Non-bottleneck-1D are replaced with one-dimensional dilated convolution, to realize refined extraction of features of the sample images;
iii. The feature images are decoded after the encoding portion completes the feature extraction of the sample images. The decoding portion consists of an up-sampling module and a residual module, and has 7 layers in total. The up-sampling portion only has a function of adjusting the fineness and matching the input, and employs simple deconvolution with a step size of 2 instead of dilated convolution or maximum unpooling. Both the residual module and the encoding portion employ Non-bottleneck-1D to refine the image features converted by the up-sampling operation;
iv. After the up-sampling and residual operation of the decoding portion, the resolution of the generated output image is restored to the level of the originally inputted image, and different types of areas in the image are labelled with different colors to distinguish them, so as to achieve a purpose of semantic segmentation of different types of objects in the image.

After the training is completed, rail area division is carried out on the original remote sensing images, and the result is shown in FIG. 3.

Appropriate onboard environment and program language for the UAV are selected, and if necessary, the environment and language adaptivity should be configured. First of all, if language conversion is needed, a formal transformation of the Largest Connected-ERFNet model should be completed. Next, initial configuration of the UAV control program is completed, a real-time video stream acquisition program for the load of the support platform of the UAV is deployed, and the Largest Connected-ERFNet model is embedded in the division and identification program for rail area of single frame image; in that way, the configuration and deployment of the model in the UAV onboard environment is completed.

Firstly, the rail areas are roughly divided from the remote sensing images by using the ERFNet portion of the Largest Connected-ERFNet model, and then the largest connected component in the division result is extracted by using the Largest Connected Component portion of the Largest Connected-ERFNet model; the largest connected component may be identified as a real rail area, while the rest connected components are identified as noise interference. The basic process of extracting the largest connected component with the Largest Connected Component portion could be summarized as follows:
i. The image is regarded as an entire area, and adjacent pixels with the same pixel value in this area may form a small area, which is referred to as a connected component. The remote sensing image is converted into a binary image with pixel values of 0 or 255 after rail area division, and the pixel neighborhood relationship includes four neighboring pixel relationship and eight neighboring pixel relationship;
ii. The pixels of the binary image are traversed to find the first pixel whose pixel value has changed, i.e., an edge pixel of the connected component. The pixel points having a neighborhood relationship with that point are judged, and the points having the same pixel value as that point are divided into the same category, i.e., they belong to the same connected component. The subject matter of calibration is moved to a neighboring pixel point of the same category, and pixel points having a neighborhood relationship with the current pixel point is judged again, and so on, till there are no pixel point that can be calibrated; these calibrated points together form a small connected component;
iii. The process (ii) is repeated to complete the processing of all pixels in the image, so as to obtain all connected components contained in the image. The number of pixel points contained in each connected component are counted, the connected component having the largest number of pixels is reserved, and is considered as a valid connected component representing the real rail area, while the pixel values of the pixels contained in the remaining interfering connected components are modified to 0 to be excluded.

The Largest Connected Component portion is used to extract the largest connected component, and area screening and extraction is completed after rough division of the real rail areas in the remote sensing image. The screening and extraction result is shown in FIG. 4.

The link system module employs a point-to-point two-way communication data transmission link and a one-way image transmission link, and employs a QPSK modulation mode. The control link should support 5G link transmission control instructions and support more than 10 control channels; the image link should support more than 10 control channels and support an OcuSync or Lightbridge image transmission system.

The safety protection module should have normal functions including under-voltage protection, one-button return, safe mode switching, and link disconnection protection mechanism, while the electronic fence should be set specially according to specific requirements in different scenarios.

### Embodiment 2

Based on the existing geographic information system of railway stations and lines, an electronic fence in special scenarios of high-speed railway is set for the UAV by using database management technology and mode, and the electronic fence is embedded in the background software for the UAV flight to prevent the UAV from intruding into the railway safety clearance. The UAV-based railway inspection (automatic enroute flight/manual flight) combined with the electronic fence function in special scenarios of high-speed railway can restrict the UAV to fly outside the railway safety clearance to avoid accidents, for example, UAV falling into a railway running section. The main parameters of the electronic fence in special scenarios of high-speed railway include rail plane, longitudinal reference line, lateral distance and relative flight altitude.

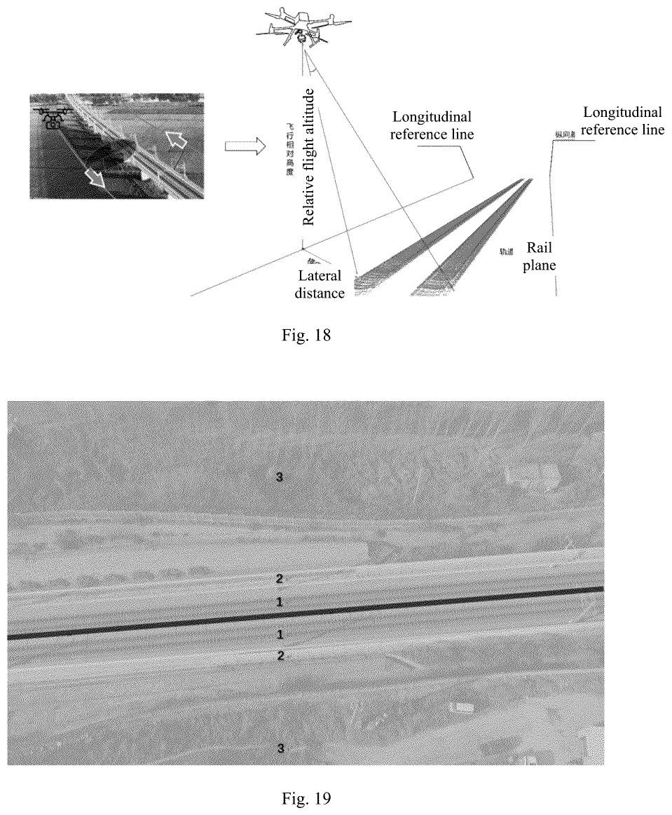

As shown in FIG. 18, the rail plane refers to the horizontal plane where the two rails are located within a certain distance; the longitudinal reference line refers to the projection line on the rail plane of the flight trajectory when the UAV flies parallel to the rails at a certain altitude; the lateral distance refers to the horizontal distance between the longitudinal reference line and the edge of the rail area; and the relative flight altitude refers to the distance between the flight position of the UAV and the rail plane. Before the flight mission is commenced, it is necessary to set corresponding parameters of the electronic fence for the UAV according to the specific inspection scenario of high-speed railway to ensure successful flight operation.

The LIDAR module employs a laser scanner with inclined elliptical scanning mode, which is an IMU with high-precision, and is equipped with 1 to 2 antennas, the maximum detection distance and point resolution also need to be set. It is required that the LIDAR module can acquire accurate 3D data quickly even in remote areas; the laser beam can penetrate vegetation and produce double echoes; the LIDAR module supports one-button system startup; real-time monitoring the working state of the system through operation; and viewing the point clouds in real time, etc.

The infrared thermal imaging module realizes an infrared imaging function, and should have more than or equal to 300,000 effective pixels and 8 to 14 μm wavelength range, and the lens can achieve more than 4× optical zooming.

The image acquisition module preferentially uses a zoom camera and a fixed focus camera for data acquisition, and is equipped with an UAV flight monitoring camera; the acquired data is transmitted back to the working computer in real time via the link system module for UAV flight monitoring. In order to achieve the accuracy of data acquisition and the automatic real-time adjustment function of UAV, the content of rapid object recognition is detected by the monitoring camera via the embedded system.

The ground base station mainly comprises a device replacement module, a data dumping module and ground take-off and landing module, wherein the data dumping module dumps the data to the PC of the ground base station, and the data is transmitted to the working computer terminal via network signals.

The working computer is a high-performance PC, which mainly comprises a monitoring module, a data dumping module and an image processing module, wherein the monitoring module mainly includes a UAV flight route planning program which directly transmits instructions to the flight control and navigation system of the UAV; the UAV real-time monitoring and operating the system, which can send back the video images of the UAV that is performing the flight mission in real time, and can take over the automatic flight of the UAV at any time and change the operating mode to manual operation.

The data dumping module comprises a UAV image storage area and a LIDAR point cloud data storage area, and this module preferably utilizes an SSD hard disk to speed up the reading and writing.

The image processing module comprises an image preprocessing and integration algorithm, a deep learning network model and a post-processing algorithm for the detection result. The model requires model base management and should have the following functions: the model management, which includes presetting a trained AI model and supports the functions of import, export, update, release, migration and version control of the model, etc.; it should support model update and deployment by means of visual aided development tools, multi-model fusion development, and secondary training of the model, etc.

Specifically, the deep learning network model includes a CYOLO-based fastener defect detection algorithm (CYOLO is a positioning network based on a cascaded multi-attention mechanism, i.e., cascaded YOLO), a segmentation algorithm for rail surface based on a rail boundary guidance saliency detection network (RBGNet), a defect detection algorithm for bridge steel structure surface based on improved YOLOv5, and an intelligent identification algorithm for abnormalities in the surrounding environment during railway operation.

As shown in FIG. 5, firstly, the CYOLO-based fastener defect detection algorithm takes Darknet53 as the backbone of the network. The network has four down-sampling layers in total, each of the down-sampling utilizes a 3*3 convolution kernel and basic convolution operation with a step size of 2. Then, the features outputted by the third down-sampling layer are inputted to eight residual blocks, and the features outputted by the residual blocks are resized to form feature information in the same size as that in the next layer, and the resized feature information is directly cascaded to the a 26*26 output feature map, thus forming a top-down feature fusion path based on a feature pyramid. Then, the six boxes obtained by using K-means are regressed and classified on the output feature map at the two scales, wherein, predictions of the larger three boxes are performed on the 26*26 scale output feature map, while predictions of the remaining three boxes are performed on the 52*52 scale output feature map.

In the experiment using fastener data set, the traditional object detectors (e.g., HOG+SVM) are compared with deep learning object detection networks (e.g., two-stage Faster R-CNN, FPN-based Faster R-CNN and one-stage YOLOv3 network), and different feature extraction networks such as VGG16, ResNet50 and ResNet101 are used. The number of steps for network training is 20000, and a stochastic gradient descent algorithm is used, with the learning rate set to 0.001 and the momentum set to 0.9. The detection threshold of defects is set to 0.6, and the detection indicator is mAP.

TABLE 1
Comparison Result of UAV Railway Fastener Data Set Algorithms

| Model | Backbone Network | mAP |
|---|---|---|
| HOG + SVM | — | 40.3 |
| YOLOv3 | Darknet | 56.3 |
| Faster R-CNN | VGG16 | 65.7 |
| Faster R-CNN | ResNet50 | 72.3 |
| Faster R-CNN | ResNet101 | 78.5 |
| FPN (faster R-CNN) | ResNet101 | 78.2 |
| CYOLO | ResNet101 | 82.6 |

According to the experimental result in Table 1, it can be seen that the CYOLO algorithm using the railway fastener data set has achieved a mAP value of 82.6, which is 5.7% higher than that achieved by the traditional YOLOV3 algorithm. Thus, it can be seen that the CYOLO algorithm has achieved a better result for the defects detection of fastener component acquired by a UAV, and has an obvious practical application value. FIG. 6 shows the effect of fastener defect detection.

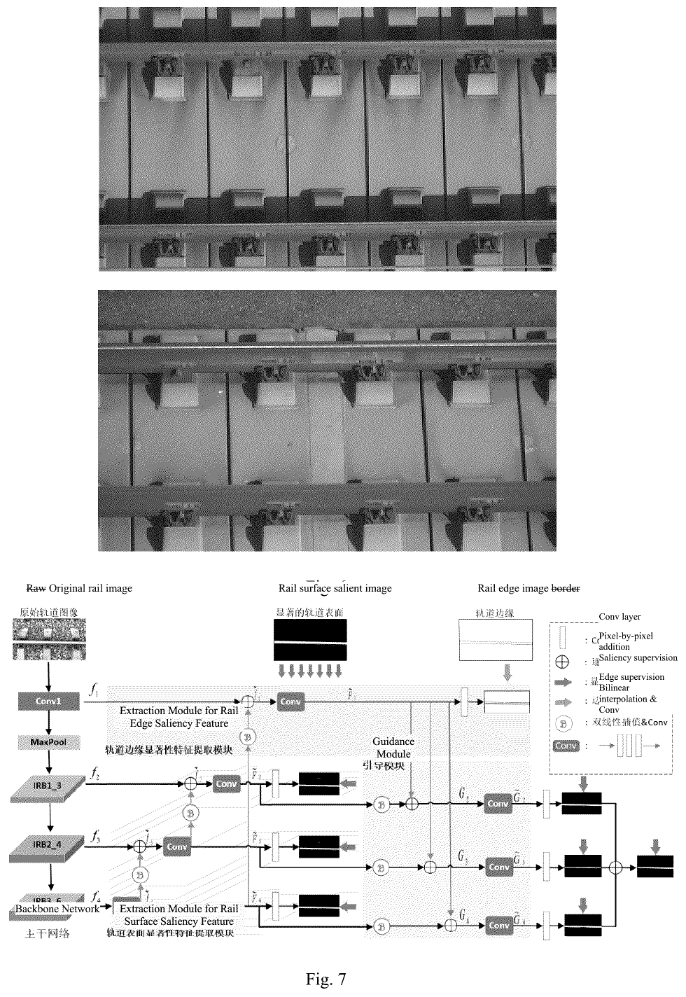

In the aspect of rail defect detection for railway lines, a rail surface segmentation method based on rail boundary guidance saliency detection network (RBGNet) and a rail surface defect detection method based on local Weber-like contrast and maximum entropy of grayscale extension are proposed. The RBGNet mainly consists of four modules and a supervised saliency detection, wherein the four modules are an improved residual block (IRB)-based backbone network module, a feature extraction module for rail edge saliency, a feature extraction module for rail surface saliency, and a guidance module, as shown in FIG. 7.

The configuration of the backbone “etwo'k Is shown in Table 2. Three TRBs are used as the basic units of the backbone network of RBGNet, and three edge paths are generated. The backbone network is not built with a fully connected layer, but it includes a Conv layer for generating the path on the other side and a Maxpool layer for reducing parameters. Therefore, four edge path feature sets from Conv1, IRB1_3, IRB2_4 and IRB3_6 of the backbone network can be acquired. The RBGNet utilizes Conv1 to extract rail edge features, and utilizes other edge paths to obtain salient rail surface features.

TABLE 2
Configuration of the Backbone Network

| | | | | | Output |
|---|---|---|---|---|---|
| Layer | Type | Filter size | stride | Padding | channels |
| Conv1 | | 7*7 | 3 | 3 | 64 |
| Max pool | | 3*3 | 2 | 1 | 64 |
| IRB1 | Bottleneck | $\{ \begin{matrix}1 \times 1 \times 64 \\ 3 \times 3 \times 64 \\ 1 \times 1 \times 256\end{matrix} \} \times 3$ | 1 1 1 | 1 | 64 64 256 |
| IRB2 | Bottleneck | $\{ \begin{matrix}1 \times 1 \times 128 \\ 3 \times 3 \times 128 \\ 1 \times 1 \times 512\end{matrix} \} \times 4$ | 1 1 1 | 2 | 128 128 512 |
| IRB3 | Bottleneck | $\{ \begin{matrix}1 \times 1 \times 256 \\ 3 \times 3 \times 256 \\ 1 \times 1 \times 1024\end{matrix} \} \times 6$ | 1 1 1 | 1 | 256 256 1024 |

The feature extraction module for rail surface saliency is a module configured to produce multi-resolution features in the RBGNet, and it adds a convolution operation to the edge paths of the backbone network to obtain more rail surface saliency information, and adds a nonlinear activation function (ReLU) layer after each convolution layer to ensure the nonlinearity of the model. The RBGNet uses a top-to-bottom location information propagation mechanism, and fuses higher-layer information into each edge path feature. Assume that the fusion feature set is:

$$i . f = \{ {f}_{1} , {f}_{2} , {f}_{3} , {f}_{4} \} \qquad ( 1 )$$

Then each fused feature can be calculated with the following formula:

$$( 2 ) {f}_{n} = {f}_{n} + Φ ( Γ ( Trans ( {F}_{n + 1} , ε ( {f}_{n} ) ) ) , μ ( {f}_{n} ) ) , n = 2 , 3 \qquad ( 2 )$$

$$i . {f}_{4} = Ψ ( {f}_{4} ) , n = 4 \qquad ( 3 )$$

Where Trans(input, ε(*)) represents a convolution operation for changing the number of feature output channels to ε(*), ε(*) is the number of feature channels of *, and Γ represents a ReLU operation; Φ(input, μ(*)) represents a bilinear interpolation, which is used to change the shape of input to μ(*), μ(*) represents the size of *, and Ψ(*) represents a series of convolution and nonlinear operations.

Finally, a convolution operation is used to enhance the salient rail surface feature. Therefore, in each edge path, the enhanced rail surface feature can be defined as:

$$i . {F}_{n} = Ψ ( {f}_{n} ) , n = 2 , 3 , 4 \qquad ( 4 )$$

The feature extraction module for rail edge saliency is used to create a model of salient rail edge information. The larger the receptive field of higher-layer feature mapping, the more accurate the positioning is. Therefore, in order to inhibit non-edge saliency information, context information of higher-layer rail surface is added to the edge feature f₁. The enhanced salient rail edge feature may be defined as:

$$1. {F}_{1} = Ψ ( {f}_{1} + Φ ( Γ ( Trans ( {f}_{4} , ε ( {f}_{1} ) ) ) , μ ( {f}_{1} ) ) ) \qquad ( 5 )$$

The enhanced feature set F composed of rail edge saliency features and rail surface saliency features can be defined as:

$$i . F = \{ {F}_{1} , {F}_{2} , {F}_{3} , {F}_{4} \} \qquad ( 6 )$$

Under the guidance of the rail edge information, the guidance module accurately predicts the rail surface position and the rail edge. More importantly, for the rail surface position prediction for each edge path, the details of segmented rail surface can be enriched, and the higher-layer prediction can be more accurate by adding salient rail edge information. Assume that the fused rail surface saliency guidance feature set is:

$$1. G = \{ {G}_{2} , {G}_{3} , {G}_{4} \} \qquad ( 7 )$$

Then, each fused guidance feature can be similarly expressed as:

$$( 1 ) {G}_{n} = Φ ( Γ ( Trans ( {F}_{n} , ε ( {F}_{1} ) ) ) , μ ( {F}_{1} ) ) + {F}_{1} , n = 2 , 4 \qquad ( 8 )$$

$$1. {G}_{n} = Ψ ( {G}_{n} ) \qquad ( 9 )$$

where, Trans(⋅), Γ(⋅), Φ(⋅) and Ψ(⋅) respectively represent a convolution operation, a ReLU operation, a bilinear interpolation operation, and a series of convolution and nonlinear operations. Therefore, a reinforced rail surface feature set guided by a set of rail edges can be obtained:

$$1. G = \{ {G}_{2} , {G}_{3} , {G}_{4} \} \qquad ( 10 )$$

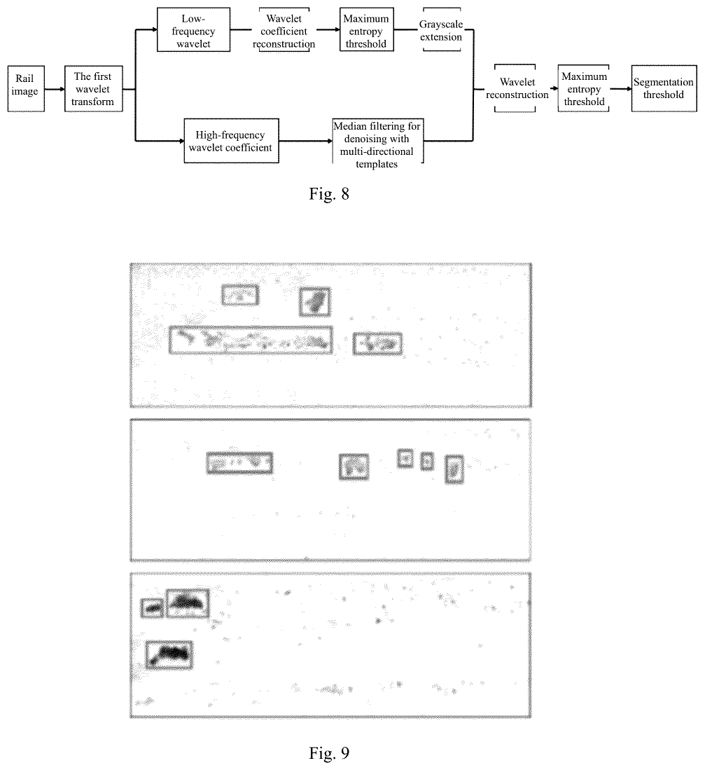

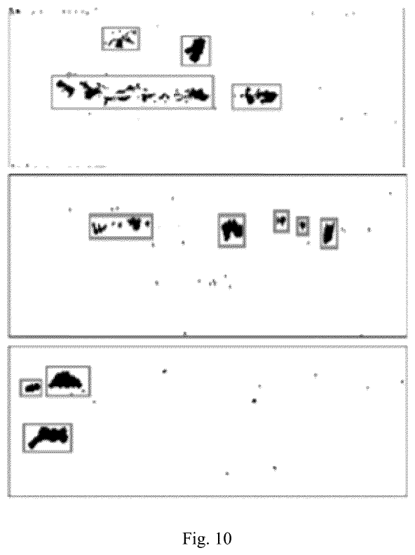

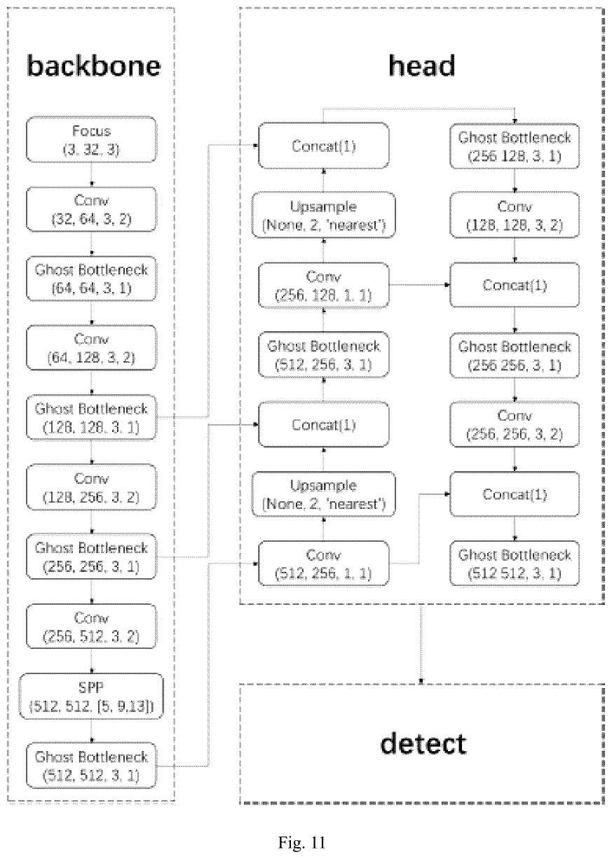

By using a method based on the local Weber-like contrast law, the rail images are enhanced to adapt to different sunlight intensities and eliminate significant changes of image grayscale. A surface detection method based on maximum entropy of grayscale extension is used to detect defective objects. The steps of the method are shown in FIG. 8. If the red rectangle of the predicted defect overlaps with the corresponding true value by more than 85%, the predicted defect is judged as true; otherwise, the predicted defect is judged as false. Then a ratio of correctly identified defects to the total number of defects is calculated. True Positive (TP), False Positive (FP), True Negative (TN) and False Negative (FN) are calculated, and the performance evaluation indicators of the model, including P (precision rate), R (recall rate), AP (average precision) and mAP (mean average precision), are calculated. The enhancement effect of the local Weber-like law and the detection result of maximum entropy of grayscale extension are shown in FIGS. 9 and 11.

In the aspect of bridge steel structure, a steel structure surface defect detection method based on improved YOLOv5 is proposed. The YOLOv5 algorithm is a one-stage object detection algorithm based on a convolutional neural network, and it uses a regression method to predict the information of the entire image; the improved YOLOv5 algorithm adds a Ghost Bottleneck module to greatly reduce the parameters generated by training and the memory occupancy while the final detection accuracy is kept unchanged. By replacing the original Bottleneck module with a Ghost Bottleneck, the structure of improved YOLOv5 network is shown in FIG. 11.

In this experiment, the test accuracy in different cases, training parameters and memory occupancy of YOLOv5 models of different sizes before and after the improvement are compared in the data set of steel structures of railway bridge. The detection indicator is mAP0.5, and the experimental result when epoch is 100 is as follows:

TABLE 3
Comparison Result of Steel Structure Data Sets of Railway Bridge

| | | | | Rusted | | | |
|---|---|---|---|---|---|---|---|
| | Normal | Missing | Rusted | steel | | | |
| | bolts | bolts | bolts | structures | Parameters | GFLOPS | Gpu_mem |
| YOLOv5s | 0.981 | 0.995 | 0.983 | 0.635 | 7263185 | 16.8 | 4.51 |
| YOLOv5s + ghost | 0.980 | 0.995 | 0.989 | 0.594 | 4709185 | 10.9 | 2.84 |
| YOLOv5m | 0.977 | 0.954 | 0.983 | 0.674 | 9572945 | 23.2 | 6.53 |
| YOLOv5m + ghost | 0.972 | 0.995 | 0.985 | 0.656 | 7835953 | 18.4 | 3.83 |
| YOLOv51 | 0.979 | 0.956 | 0.980 | 0.696 | 11882705 | 25.9 | 7.40 |
| YOLOv51 + ghost | 0.968 | 0.995 | 0.979 | 0.674 | 9671297 | 23.2 | 7.58 |

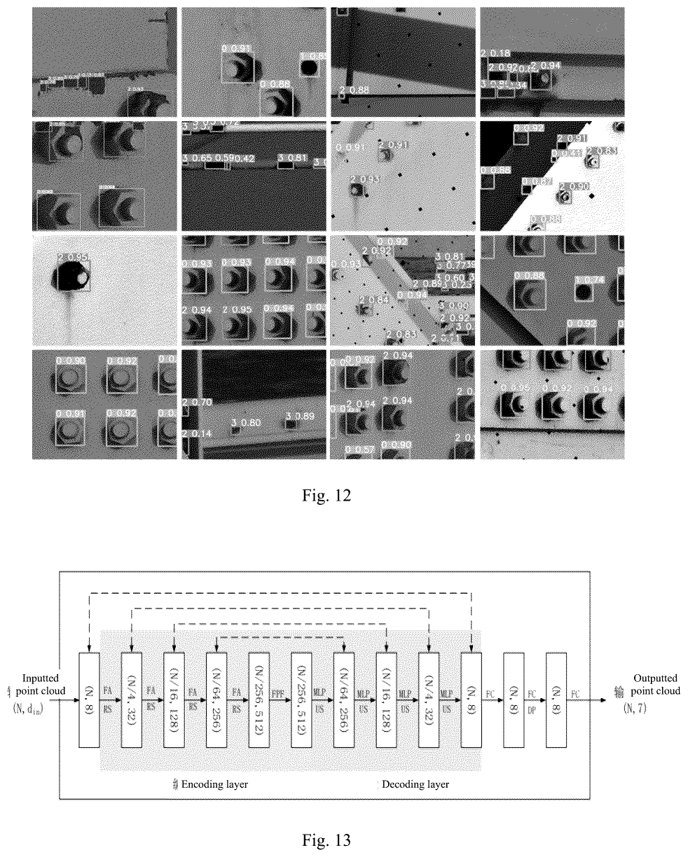

In general, under the condition that the precision of the test data is basically unchanged, the running parameters and computational complexity of the improved model are greatly reduced, and the memory occupancy is greatly reduced. According to the comparison of model training using this data set, the model using YOLOv5m+ghost is more effective in training and detection. The effect of bridge steel structure defect detection is shown in FIG. 12.

In the aspect of the surrounding environment along the railway, a method for detecting the abnormalities in the surrounding environment along the railway based on multi-source data fusion is proposed. Firstly, feature analysis and data preprocessing are carried out on the point cloud data, the point cloud data is segmented by using a large-scale point cloud semantic segmentation model based on random sampling, feature aggregation and prototype fitting, the point cloud is clustered by using an improved Euclidean algorithm, the objects are identified by using a deep learning instance segmentation method based on transfer learning, and finally, the abnormalities of the surrounding environment along the railway are intelligently identified by using a method of fusing the point cloud data and a visible light image recognition result in a serial decision level.

In the aspect of onboard LIDAR point cloud data processing, for the noise existed in the point cloud data acquired by the onboard LIDAR, outliers are processed with a method based on statistics, and redundant points are processed based on the nearest distance method. For ground points that account for a large proportion of the overall data, the ground points are filtered off with a cloth simulation filtering method. Then, a large-scale point cloud semantic segmentation method based on random sampling, feature aggregation and prototype fitting are proposed, and the network structure is shown in FIG. 13. The experimental comparison result demonstrates that the method is better than the existing methods in terms of the segmentation effect, and the method also has a better performance on small samples data. For a point cloud in the abnormality category obtained by segmentation, clustering is carried out with an improved Euclidean algorithm to extract individual abnormal objects. For a point cloud of abnormal objects, a method for calculating the volume of an irregular point cloud based on Alpha-shape algorithm is proposed. The experimental result demonstrates that the method is better than the existing methods in terms of accuracy, robustness and applicability, and has a faster computing speed. Finally, a method for calculating the shortest distance between an abnormal object and the rail is proposed, which involves point cloud edge extraction, linear fitting and coordinate transformation, and can eliminate the error caused by incomplete rail edge scanning to some extent.

In the aspect of image data processing, for the problem of low illumination existed in some visible light data, an ElightenGAN algorithm is used to enhance the illumination; for the problem of small object existed in the data, a Mosaic method is used to enhance the data; for the problem of inadequate sample size, a transfer learning method is used to increase the knowledge on common features to the algorithm, and then a YOLACT algorithm is used to segment visible light image data instances. Experiments demonstrate that the method has excellent performance in segmentation accuracy and detection recall rate, and the effect of the algorithm is improved to some extent by data enhancement.

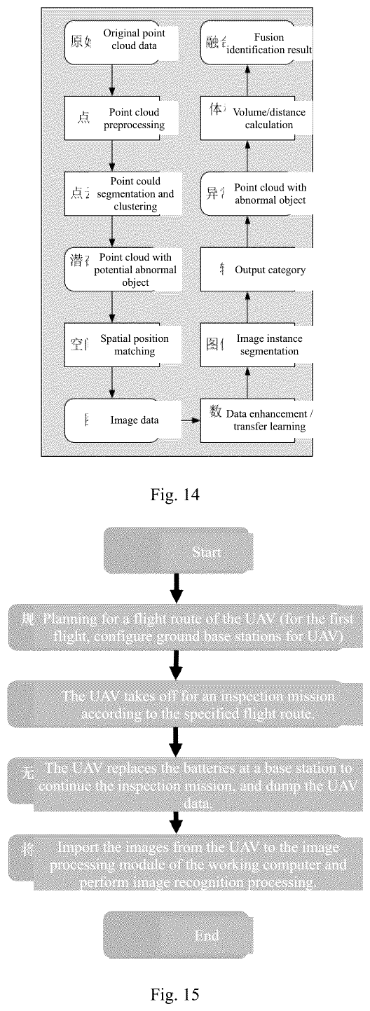

In the aspect of the fusion of point cloud data and visible light data, in view of the problems such as the inconsistency in coverage and severe difference in data volume between point cloud data and visible light image data, a decision level fusion method is selected for data fusion, and a serial data fusion method is proposed. The specific process of the method is shown in FIG. 14. The method is based on the point cloud recognition result, and utilizes the image recognition results to categorize potential abnormal objects. The experimental result demonstrates that the method has advantages of accurate and comprehensive result, and high fault tolerance, and also proves the significance of multi-source data fusion for recognition of abnormalities in the railway operating environment.

FIG. 15 is a flowchart of the steps of automatic inspection with a UAV, including planning a flight route of the UAV, instructing the UAV to take off according to the specified route for an inspection mission, replacing the batteries at a base station to continue the inspection mission during the inspection with the UAV, dumping the data of the UAV, importing the images from the UAV into an image processing module of the working computer and performing image recognition processing.

The specific steps are as follows:

Step 1: planning a flight route for the UAV;

A flight route is planned for the UAV via the monitoring module of the working computer, the flight route includes flight distance, flight altitude, the distance between the UAV and the railway, number of flights/round trip or not, flight speed, and replacement of the load or not, etc.; and the flight mission is configured, including content of shooting, key objects of shooting, flight mode/hovering or not, etc. During the first flight, it is necessary to establish a three-dimensional point cloud model with LIDAR point cloud data, and configure the ground base stations for the UAV to realize long-distance flight.

Step 2: instructing the UAV to take off according to the specified route for the inspection mission;

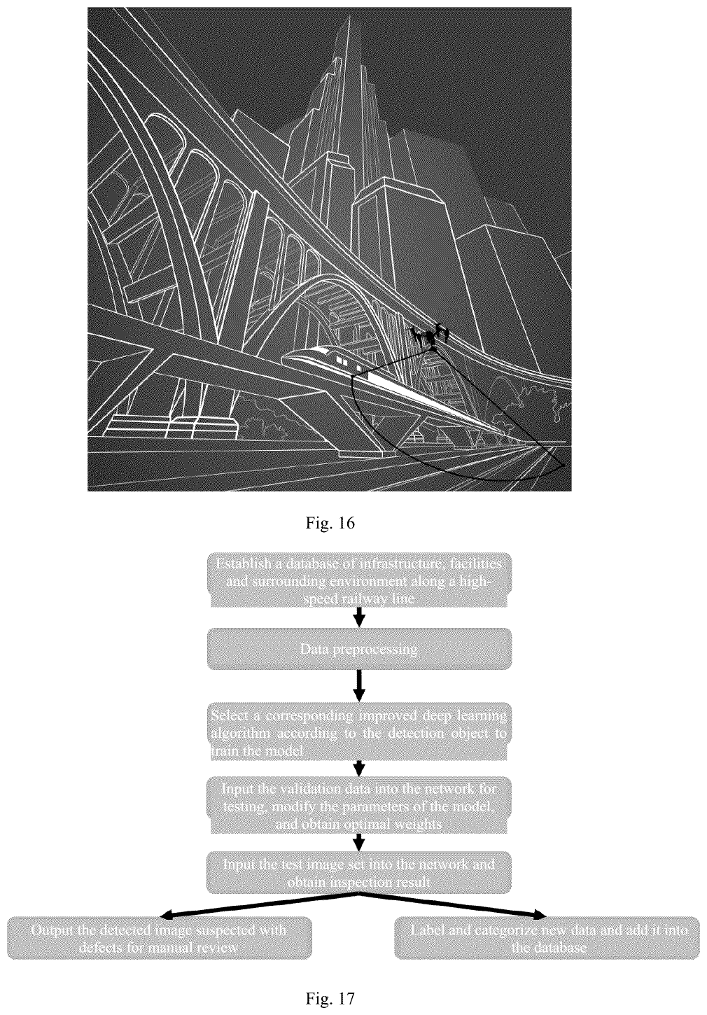

The flight state of the UAV can be detected in real time via the monitoring module of the working computer, the flight state includes flight speed of UAV, flight altitude of UAV, ambient wind speed, UAV temperature, battery power, motor state, signal strength, etc.; the viewing angle of the UAV can be obtained through returning video in real time, and the flight of the UAV can be taken over at any time.
As shown in FIG. 16, the UAV performs a routine inspection operation according to the multi-rotor inspection plan for the toe of embankment, or the top of cutting slope, or an area of within 200 m to the outside of the railway bridge at an altitude of 50 to 100 m and a distance of 80 to 160 m from the railway in the lateral direction.

Step 3: during the inspection with the UAV, replacing the batteries of the UAV at a mobile base station to continue the inspection mission and dumping the UAV data there. After flying in the vicinity of the ground base station, the UAV will automatically fly to the ground base station to replace the batteries to ensure the power supply required for its long-distance flight, and to dump the obtained image data to ensure the data integrity in the long-distance flight;

Step 4: importing the images from the UAV into the image processing module of the working computer and performing image recognition processing.

After obtaining the data from the UAV, the ground base station directly uploads the data to the working computer, and a corresponding folder is created according to the flight mission. The collected images are performed with pre-processing that includes contrast adjustment, image defogging, reducing the influence of light and shadow, etc., to achieve an image enhancement effect; the obtained images are inputted into the intelligent analysis system, and different detection objects are inputted into different network models for testing, so as to achieve a high recall rate. After the detection result is obtained, the images labelled with defects are checked manually, and, for images whose problems are confirmed, the locations of the images are calculated, and the images are recorded.
As shown in FIG. 17, the intelligent image analysis system perform operations, including establishing a database of infrastructure and surrounding environment along the high-speed railway, preprocessing the new data acquired by the UAV, and inputting the data into a deep learning model for iterative training to enhance the robustness of the model, wherein the deep learning model includes object detection network models YOLOv5, SSD, Faster R-CNN, FPN, etc., and semantic segmentation network models YOLACT and Deeplabv3+, etc. The validation data set is inputted to verify the training effect of the model, and the parameters are adjusted in real time according to the effect; or the current trained model is neglected, and the training is restarted with the weights obtained last time to achieve an optimal result; and the weights are recorded for new image detection. The newly obtained data is used as a test set for image object recognition. After the detection result is obtained, the images labelled with defective problems are checked manually, and, for the images that are confirmed as involving problems, the locations are calculated and the images are recorded; besides, the data newly obtained this time is expanded by data preprocessing that includes image rotation, image scaling, image resolution adjustment and noise addition. The expanded data is added into the training validation database. At the same time, the defects are manually labelled with related image annotation software to generate data that includes image name, defect category and defect coordinates. Meanwhile, a K-means clustering algorithm is used to judges the similarity of different samples by calculating the distance between them, and similar samples are grouped into the same category. The K-means algorithm is used to calculate the size and aspect ratio of the prior anchor box, to ensure that the anchor box covers all the object defects as far as possible.

The training set and validation set are composed of a database of infrastructure and surrounding environment along the high-speed railway and a tag file in combination, and the newly acquired data is used as the test set.

On the basis of the intelligent analysis system for automatic inspection of a high-speed railway line with a UAV, different flight parameters and flight modes are set for different flight scenarios. For three scenarios, i.e., railway line, railway tunnel entrance and railway bridge, the main working modes of the UAV in the flight inspection are shown in FIG. 18. In the process that the UAV flies along the longitudinal reference line at a certain altitude above the rail plane at a certain lateral distance from the rail area, by continuously adjusting the load attitude of the UAV, data acquisition is carried out for relevant infrastructure and facilities or key components and parts in the railway area. Two operating modes can be selected for the flight test of railway inspection with the UAV: manually controlled flight and automatic flight of UAV. In the automatic flight mode, the UAV can maintain a relatively constant flight speed, and usually an appropriate flight speed is selected. If the flight speed is too high, the acquired images may be blurred; if the flight speed is too low, the time consumption of a single flight test will be severe and more battery power will be consumed, which will adversely affect the overall flight test progress. Therefore, it is very important to set a reasonable flight speed. In the manual flight mode, the flight of the UAV is fully controlled manually, and it is not easy to maintain a certain flight speed and reasonable flight direction. However, manual flight control is more suitable for acquiring data of key components that are not covered or difficult to acquire by automatic flight, and it is also a very necessary flight mode that should be taken into account.

Whatever an automatic flight mode or a manual flight mode is used, it is necessary to ensure that the UAV flies within the normal sight distance range. In the manual flight mode, the flight of the UAV can be stopped at any time according to the situation. The setting of the relative flight altitude can specially take into account the specific situation of the railway line. For the two scenarios of railway line and railway tunnel entrances, the set range is generally smaller than that for the scenario of railway bridges, because it is necessary for the UAV to acquire data of key components of the bridges at a specific angle (elevation angle) in the railway bridges scenario, where the relative altitude may be negative. For example, in order to take images of the details of infrastructure such as bridges and viaducts, such as nuts on supports and nuts on bridge bodies, it is necessary for the UAV to fly below the rail plane.

Under a windy condition during the on-site operation of the UAV, the UAV should fly on the leeward side of the railway operation section, and try to avoid flying on the windward side of the railway operation section; during the flight of the UAV, it is necessary to ensure that the UAV flies within the normal sight distance range of the tester; besides, it is necessary to ensure that there is no any other building or construction that may affect the flight in the flight route area, i.e., ensure that the flight route of the UAV will not overlap with any building or tall vegetation. In addition, the flight operation process of the UAV along a high-speed railway should meet the requirements of airspace control, air danger zone, military restricted zone, national border and boundary line, etc.

Specifically, the corresponding objects in the flight are explained for inspection mission for joint operation of high-speed railway operation and environment, inspection mission for joint operation of overhead contact system and environment, and inspection mission for bridges, mountainous areas and tunnel entrances. During the flight, the coverage areas of single images, the attitude angle of the support platform, the flight speed, the flight shooting interval, the ground sampling interval, the minimum number of pixels of identifiable objects, the minimum size of identifiable objects, the relative flight altitude and the lateral safety distance should be planned in advance before the flight mission, to ensure a smooth implementation of the flight operations.

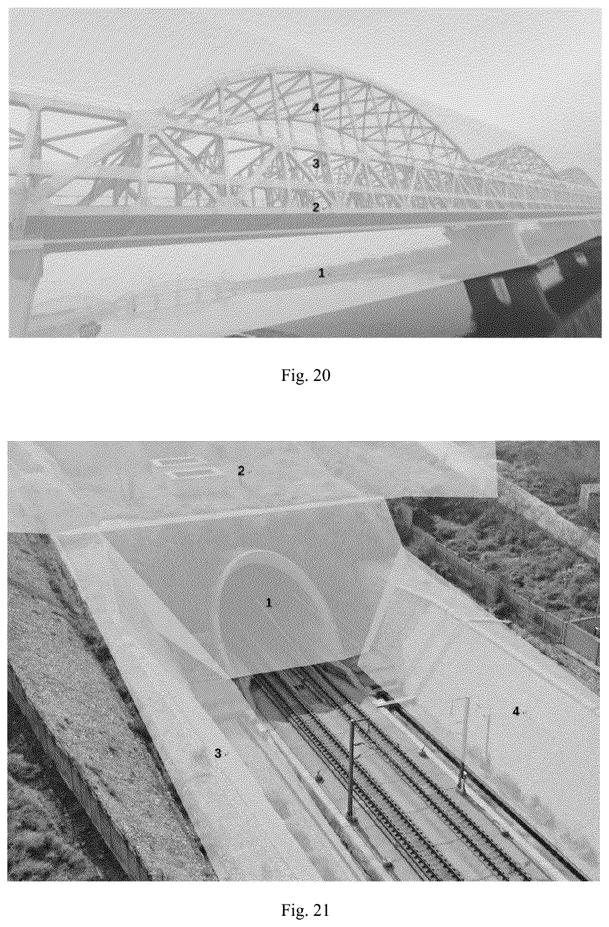

As shown in FIG. 19, when the UAV is in an inspection mission for joint operation of high-speed railway operation and environment, the focus should be set to the railway lines, noise barrier, subgrade and environment. Images of the objects related to railway operation should be mainly taken with a zoom camera. When UAV is in an inspection mission for joint operation of overhead contact system and environment, the focus should be set to the poles of the overhead contact system and the environment. The images of objects on the poles of the overhead contact system should be mainly taken with a zoom camera, and the images of the environment should be taken with a wide-angle camera. For an inspection mission for bridge areas as shown in FIG. 20, inspections of the pier and the pier body of bridge, bridge steel structures, bridge railings and other parts are carried out by inspecting each side of the bridge for several times, by utilizing a mobile UAV port. As shown in FIG. 21, for an inspection mission for mountainous areas and tunnel entrances, the UAV should perform U-shaped inspection for the surrounding environment, slopes at tunnel entrance, drainage facilities at tunnel entrance, top structure of tunnel entrance and other parts. For an inspection mission for steel towers with the UAV, the focus should be set to the inspection of tower materials, wires and bird prevention devices.

What is claimed is:

1. An automatic intelligent inspection system for the equipment, facilities and surrounding environment along a railway line, comprising:
an unmanned aerial vehicle (UAV) configured to fly along the railway line according to a preset trajectory, acquire and store image information of the equipment and facilities and surrounding environment along the railway line from a plurality of angles, and transmit the image information to a remote server;
a movable ground base station configured to enable the UAV to replace batteries and load, dump data locally, and take off and land autonomously by using a ground landing platform;
a remote server configured to receive and store the image information transmitted by the UAV; and
a working computer configured to receive the image information acquired by the UAV and transmitted by the remote server, and analyze and compute the image information, so as to obtain an inspection result;
characterized in that:
the working computer comprises an image processing module, which detects the obtained image by using a deep learning network model trained with a database in advance, obtaining any object that is suspected to involve a defect by analysis, and sends the object for manual review while calculating for the specific geographic coordinate information of the defect, reports the defect for early warning after the defect is confirmed by the manual review, informs the operation and maintenance personnel to handle the defect, and stores and records the defect,
wherein the image processing module comprises an image preprocessing and integration algorithm, a deep learning network model and a detection result post-processing algorithm, wherein the deep learning network model comprises a detection algorithm for fastener defect for railways that is based on CYOLO, a rail surface segmentation algorithm that is based on rail boundary guidance saliency detection network (RBGNet), a detection algorithm for bridge steel structure surface defect for bridges that is based on improved YOLOv5, and an abnormality detection algorithm for railway surrounding environment that is based on multi-source data fusion for environments.

2. The automatic intelligent inspection system for the equipment, facilities and surrounding environment along a railway line according to claim 1, wherein the UAV comprises a body power module, a flight control and navigation module, an embedded onboard module, a link system module, a safety protection module, a LIDAR module, an infrared thermal imaging module, and an image acquisition module, wherein
the body power module forming a main structure of the UAV comprises arms, motors, blades, batteries, a tripod and a support platform;
the flight control and navigation module are configured to feed back the geographic coordinate information of the UAV in real time, control the start and stop, flight attitude and flight speed of the UAV, and enable the UAV to fly according to a preset flight trajectory via the flight control and navigation module;
the embedded onboard module utilizes an onboard computer with optimized information transmission and storage capability and data and image processing capability to realize data processing in flight;
the link system module is configured to upload UAV control instructions and download mission information, and transmit the working state and video images of the UAV in real time;
the safety protection module is configured to confirm a specific route of the UAV according to the specific location and surrounding environment of the UAV in conjunction with the working purpose of the UAV;
the LIDAR module accurately detects the distance and the altitude by means of echo signals, so as to carry out three-dimensional mapping for cruise trajectory formulation, realize high-precision inspection with the UAV by means of sensors, while acquiring point cloud data of the surrounding environment along the railway line;
the infrared thermal imaging module accurately presents the operating state of the railway infrastructure and equipment by means of a temperature measurement function; and
the image acquisition module is configured to acquire and store the image information of the equipment, facilities and surrounding environment along the railway line in the flight route of the UAV.

3. The automatic intelligent inspection system for the equipment, facilities and surrounding environment along a railway line according to claim 1, wherein the RBGNet-based rail surface segmentation algorithm consists of four modules and a supervised saliency detection, wherein the four modules include an improved residual block (TRB)-based backbone network module, an extraction module for rail edge saliency feature, an extraction module for rail surface saliency feature, and a guidance module.

4. The automatic intelligent inspection system for the equipment, facilities and surrounding environment along a railway line according to claim 3, wherein the extraction module for rail surface saliency feature is configured to produce features with multi-resolution, add a convolution operation to the edge paths of the backbone network to obtain more rail surface saliency information, and add a nonlinear activation function layer behind after convolution layer to ensure the nonlinearity of the model.

5. The automatic intelligent inspection system for the equipment, facilities and surrounding environment along a railway line according to claim 1, wherein the bridge steel structure surface defect detection algorithm that is based on improved YOLOv5 for bridges is a one-stage object detection algorithm based on a convolutional neural network, in which the Bottleneck in the YOLOv5 algorithm is replaced with Ghost Bottleneck.

6. The automatic intelligent inspection system for the equipment, facilities and surrounding environment along a railway line according to claim 1, wherein the abnormality detection algorithm for surrounding environment of railway that is based on multi-source data fusion for environments comprises:
carrying out feature analysis and data preprocessing on the point cloud data, segmenting the point cloud data by using a large-scale point cloud semantic segmentation model based on random sampling, feature aggregation and prototype fitting, clustering the point cloud by using an improved Euclidean algorithm, identifying the object by using a deep learning instance segmentation method based on transfer learning, and finally, intelligently identifying the abnormalities of the environment around the railway by using a method of fusing the point cloud data with a visible light image recognition result in a serial decision level.

7. The automatic intelligent inspection system for the equipment, facilities and surrounding environment along a railway line according to claim 2, wherein the embedded onboard module comprises:
an onboard data access terminal configured for real-time network access from the UAV in the air; and
an onboard edge computer configured for millisecond-level real-time data transmission between the ground and the UAV via signals, wherein the embedded onboard module realizes autonomous identification and real-time tracking of the rail route by using a Largest Connected-ERFNet model algorithm.

8. The automatic intelligent inspection system for the equipment, facilities and surrounding environment along a railway line according to claim 7, wherein the Largest Connected-ERFNet model comprises an ERFNet deep learning portion and a Largest Connected Component deep learning portion, wherein
the framework of the ERFNet deep learning portion is as follows:
i. randomly selecting a corresponding number of remote sensing images from an original training data set: firstly, the image inputted to model is encoded; the encoding portion consists of a down-sampling module and an encoding residual module, wherein the down-sampling module is realized by convolution operation and max-pooling operation;
ii. the encoding residual module employs the residual module in Non-bottleneck-1D, with the last two blocks in Non-bottleneck-1D replaced with one-dimensional dilated convolution for refined extraction of sample image features;
iii. decoding the feature image after the extraction of sample image feature is completed by the encoding portion; the decoding portion consists of an up-sampling module and a decoding residual module, wherein the up-sampling portion employs deconvolution with a step size of 2, and the decoding residual module and the encoding residual module employ Non-bottleneck-1D to refine the image features converted by up-sampling;
iv. after the up-sampling and residual operation of the decoding portion, the resolution of the generated output image is restored to the level of the originally inputted image, and different types of areas in the image are labelled with different colors to distinguish them, so as to achieve a purpose of semantic segmentation of different types of objects in the image.

9. The automatic intelligent inspection system for the equipment, facilities and surrounding environment along a railway line according to claim 7, wherein the Largest Connected Component deep learning portion is configured to extract the largest connected component, including:
i. binarizing the image: the image is regarded as an entire area, and the remote sensing image is converted into a binary image with pixel values of 0 or 255 after the rail area is divided, and the pixel neighborhood relationship includes four neighboring pixel relationship and eight neighboring pixel relationship;
ii. determining a connected component: the pixels of the binary image is traversed to find an edge pixel of a connected component, wherein the edge pixel is the first pixel whose pixel value has changed; the pixels in a neighborhood relationship with said edge pixel are judged; pixels having the same pixel value as said edge pixel is allocated to the same connected component; the subject matter of calibration is moved to a neighboring pixel of the same type; pixels in a neighborhood relationship with the current pixel are judged again, and so on, till there is no pixel position that can be calibrated; the calibrated points together constitute a connected component; and
iii. repeating the process (ii) to complete the processing of all pixels in the image, so as to obtain all connected components contained in the image.

10. The automatic intelligent inspection system for the equipment, facilities and surrounding environment along a railway line according to claim 2, wherein the safety protection module comprises:
an electronic fence established around the area where the UAV is forbidden to enter to ensure that the UAV will not invade the safety clearance in the flying operation;
an under-voltage protection module configured to remind the user of flying back or landing the UAV in time when the voltage is too low;
a one-button return switch configured for activating a one-button return function of the UAV;
a safety mode setting module configured for automatically switching to manual flight when the UAV is interfered; and
a link disconnection protection module configured to make the UAV fly back to a landing point according to a preset return route when the link is disconnected.

11. The automatic intelligent inspection system for the equipment, facilities and surrounding environment along a railway line according to claim 2, wherein the image acquisition module comprises:
a high-resolution lens configured for acquiring image data;
an image acquisition control chip configured for receiving the location information of the UAV, taking images at an interval of flight distance or flight time, and receiving the image information from the camera at the same time, and detecting whether there is a target area in the image during hovering for taking images in the multi-mission flight; and, if there is a target area, giving a shooting command; otherwise transmitting a signal to the flight control and navigation system of the UAV to adjust the location of the UAV.

12. The automatic intelligent inspection system for the equipment, facilities and surrounding environment along a railway line according to claim 1, wherein the movable ground base station comprises:
a device replacement module used for receiving the UAV, replacing the batteries of the UAV, automatically replacing the load as required, and charging and storing the replaced batteries;
a data dumping module configured for dumping and backing up the data acquired by the UAV after the UAV arrives at the ground base station; and
a ground take-off and landing module configured for one-button autonomous take-off and landing of the UAV, offsite take-off and landing of the UAV, and providing energy support for field operations.

13. The automatic intelligent inspection system for the equipment, facilities and surrounding environment along a railway line according to claim 1, wherein the working computer further comprises:
a monitoring module configured to issue an automatic flight inspection mission to the UAV after accurately planning the flight route according to the LIDAR data, and monitor the flight state of the UAV in real time; and
a data dumping module configured for receiving the data returned by the ground base station and classifying and storing the data into a database of the equipment, facilities and surrounding environment along the railway line.

14. The automatic intelligent inspection system for the equipment, facilities and surrounding environment along a railway line according to claim 13, wherein the step of configuring the monitoring module comprises:
directly using the geographic coordinate information for route planning to realize automatic cruising, or taking over the UAV flight control system in real time via the monitoring system to remotely control the flight of the UAV when the UAV is to inspect the target area for the first time; and
carrying out three-dimensional modeling of the target area by using the point cloud data obtained by the LIDAR module after the first flight, determining the flight trajectory of the UAV accurately, configuring the UAV to hover at the communication towers along the railway line for taking images, and taking images after reaching the target area.

15. A method for inspection by using the automatic intelligent inspection system for the equipment, facilities and surrounding environment along a railway line according to claim 1, comprising:
configuring the image processing module;
configuring a planned flight route of the UAV, issuing a take-off command to the UAV for the inspection mission, monitoring the entire flight process of the UAV, and taking over the flight control of the UAV at any time, via the monitoring module of the working computer;
after the UAV enters the flight mission area, carrying out image acquisition according to a preselected setting, making real-time adjustment according to the actual flight state, and saving the geographical location information of the captured images together with the captured images, via the image acquisition module in the UAV; and
during an inspection flight mission of the UAV, transmitting the flight data and location information of the UAV to a flight mission server in real time by means of mobile communication signals, monitoring and managing the data via the server, returning the UAV data from the ground base station, detecting and identifying the defects in the newly received image information via the deep learning network model in the image processing module, sending a defect warning result for manual review, uploading the defect and specific location information after the defect is manually confirmed, and informing the operation and maintenance personnel and recording the defect, wherein the flight data includes the acquired image data.

16. The method according to claim 15, wherein the steps of configuring the image processing module comprise labelling the acquired images of the equipment, facilities and surrounding environment along the railway line to create a data set, and training the defective object detection model based on a deep learning network to realize automatic identification and positioning of the defects in the newly acquired data.

17. The method according to claim 16, wherein after the database of the equipment, facilities and surrounding environment along the railway line is created, automatically labelling the newly acquired images by using the deep learning network model, supplemented by manual detection and labelling, updating the database, and training and optimizing the network model again to enhance the detection ability.
